(19) United States
(12) Patent Application Publication
(10) Pub. No.: US 2014/0258720 A1
(43) Pub. Date: Sep. 11, 2014

(54) SYSTEMS AND METHODS FOR TRANSPARENT PER-FILE ENCRYPTION AND DECRYPTION VIA METADATA IDENTIFICATION

(71) Applicant: Barracuda Networks, Inc., Campbell, CA (US)

(72) Inventors: William BLACK, San Jose, CA (US); Kelly PRICE, San Jose, CA (US)

(73) Assignee: Barracuda Networks, Inc., Campbell, CA (US)

(21) Appl. No.: 14/203,974

(22) Filed: Mar. 11, 2014

Related U.S. Application Data
(60) Provisional application No. 61/775,703, filed on Mar. 11, 2013.

(51) Int. Cl. G06F 21/62

(52) U.S. Cl. CPC G06F 21/6209
USPC 713/165

(57) ABSTRACT

A new approach is proposed that contemplates systems and methods to support encryption and decryption of files including data and source code associated with a software application running in a virtual environment on a per-file basis outside of a kernel of an operating system. The proposed approach utilizes metadata of the files associated with the software application to determine the files to be encrypted and decrypted and to monitor various properties of the files including the sizes of the unencrypted files for accurate reporting of information about the files. Under such an approach, the source code of the applications are encrypted and decrypted transparently at the file level without modifying or altering any of the source code of the application, the kernel and libraries of the operating system, and/or any components which are proprietary to the virtual environment.

### RELATED APPLICATIONS

This application claims the benefit of United States Provisional Patent Application No. 61/775,703, filed Mar. 11, 2013, and entitled “Transparent Per-File Encryption and Decryption by Meta Data Transformation and Library Call Hooking Methods,” and is hereby incorporated herein by reference.

### BACKGROUND

Many hardware appliances and software services utilize and depend on one or more interpreted languages such as Perl, Python, and others, which provide executable plain text scripts/source code of software products and services without requiring compilation. Programs of software products and services written in interpreted languages are gaining popularity because they are easy to write and to debug, leading to quick time-to-market of the products and services.

Advantageously, software products and services written in the interpreted languages can be migrated to a virtual environment, where multiple virtual machines/appliances in multiple emulated environments (such as operating systems) run on top of a hypervisor on a physical (computing) device or host. Each virtual machine performs I/O operations and stores its source code and data to a virtual logical disk or volume, which maps to a physical computer readable storage device of the host. With the popularity of the virtual environment, it is easy to scale and redistribute the virtual software products and services over the Internet to numerous physical storage devices and hosts. As a result, such physical storage devices become more easily accessible to malware developers or other entities wishing to convert or damage the software products and services, wherein the malware developers or other entities may access the plaintext source code of programs written in interpreted languages by examining the disks in the physical storage devices.

Although block-device encryption in the kernel of an operating system such as Linux, where the entire virtual disk is encrypted, may protect the software products and services in conventional circumstances, not all virtual environments support this type of block-device encryption. In addition, it is undesirable to require modifications to the virtual environment or to develop, manage, and maintain a divergent second version of the product to operate on encrypted files solely for virtual appliances.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 shows an example of a system diagram to support encryption and decryption on per-file basis via metadata identification.

FIG. 2 depicts a flowchart of an example of a process to support encryption and decryption on per-file basis via metadata identification.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support encryption and decryption of files including data and source code associated with a software application running in a virtual environment on a per-file basis outside of a kernel of an operating system. The proposed approach utilizes metadata of the files associated with the software application to determine the files to be encrypted and decrypted and to monitor various properties of the files including the sizes of the unencrypted files for accurate reporting of information about the files. Under such an approach, malware developers are prevented from being able to inspect executable plain text scripts of applications running in virtual environments that disallow block-level encryption to protect intellectual property and/or proprietary information of the user and/or business entity of the software application. In addition, the source code of the applications are encrypted and decrypted transparently at the file level without modifying or altering any of the source code of the application, the kernel and libraries of the operating system, and/or any components which are proprietary to the virtual environment.

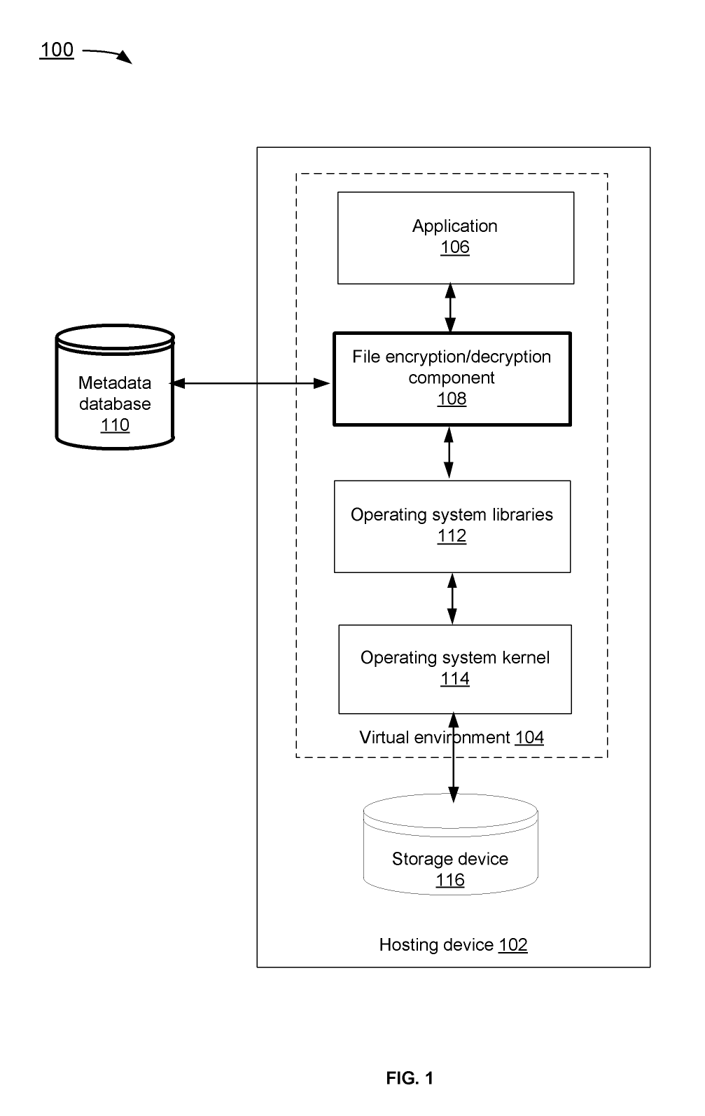

FIG. 1 shows an example of a system diagram to support encryption and decryption on per-file basis via metadata identification. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least file encryption/decryption component/layer 108 and metadata database 110. As used herein, the term component/layer refers to software, firmware, hardware, or other component that is used to effectuate a purpose. The component/layer will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers.

In the example of FIG. 1, the file encryption/decryption component/layer 108 runs on at least one hosting device or host 102. Here, host device 102 can be a computing device, a communication device, a storage device, or any electronic device capable of running a software component. For non-limiting examples, a computing device can be but is not limited to a laptop PC, a desktop PC, an iPod, an iPhone, an iPad, a Google's Android device, or a server machine. A storage device can be but is not limited to a hard disk drive, a flash memory drive, or any portable storage device. A communication device can be but is not limited to a mobile phone.

In the example of FIG. 1, a physical storage device 116 of the hosting server 102 includes a disk controller (not shown) coupled to an array of computer readable physical storage components, such as hard disks. It is well known to one ordinarily skilled in the art that each disk of the storage device 116 may include multiple partitions and each partition includes a plurality of blocks for data storage.

In the example of FIG. 1, an (software) application 106 runs in an operating system (OS) running on the hosting device 102, wherein source code and data associated with the application 106 are stored in a physical storage device 116. For a non-limiting example, the OS can be but is not limited to Linux Operating System or Windows Operating System. In some embodiments, the application 106 runs in a virtual environment 104, such as a virtual machine (VM), which is a software implementation of a physical machine (i.e. a computer) that executes programs to emulate an existing computing environment such as an OS. The VM runs on top of a hypervisor (not shown), which controls processor, storage, as well as other computing resources of the hosting device 102. When running in the virtual environment 104, the application 106 is referred to as a virtual application or alliance, which interacts with the hosting device 102 via the virtual environment 104. In some embodiments, source code of the application 106 is written in an interpreted language, such as Perl or Python, which is an executable plain text script stored on the physical storage device 116. In some embodiments, the application 106 interacts with the physical storage device 116 via a virtual disk or vdisk (not shown), which is a virtual logical disk or volume mapped to the physical storage device 116 and managed by the virtual environment 104.

In the example of FIG. 1, a file encryption/decryption layer or component 108 is logically interposed between the application 106 and the operating system libraries 112, wherein the file encryption/decryption component 108 is configured to encrypt or decrypt certain files accessed by the application 106 on a per-file basis. In some embodiments, the file includes source code and/or data to be accessed by the application 106. In some embodiments, the operating system libraries 112 can be but are not limited to standard C libraries (e.g., libc). When the application 106 invokes certain Application Programming Interface (API) calls to the operating system libraries 112 to perform one or more operations on a file stored on the physical storage device 116, the file encryption/decryption component 108 intercepts such API calls to the operating system libraries 112 and alters the calls to perform encryption and/or decryption of the file to be accessed by the application. For non-limiting examples, the operations performed on the file stored on the physical storage device 116 include but are not limited to, open, read, write, and close operation of the file. In some embodiments, the file encryption/decryption component 108 encrypts and/or decrypts only a portion of the file that is related to confidential information or intellectual property of the user or the entity that owns the file. In some embodiments, the file encryption/decryption component 108 enables API calls that are unrelated to certain operations on the file to pass through to the operating system libraries 112 without modification or alteration.

In some embodiments, the file encryption/decryption component 108 diverts the API calls to encrypt/decrypt the file being accessed by dynamically altering a link to a library for the API calls. In the example of a typical Linux-based operating system, such dynamic altering of the linked library can be implemented using a library preloading setting such as LD_PRELOAD environment variable, which specifies a program library whose functions override those subsequently loaded libraries such as the operating system libraries 112. Using such LD_PRELOAD setting, the file encryption/decryption component 108 effectively “hooks” and redirects the API calls to the operating system libraries 112 for standard file input/output operations such as open( ) read( ) and write( )to an alternative library (not shown) to encrypt the file for a write operation and to decrypt the file for a read operation first before the standard file input/output operations.

In the example of FIG. 1, the file encryption/decryption component 108 and the operating system libraries 112 stores and/or retrieves the encrypted file to the physical storage device 116 by communicating with and invoking function calls provided by interface of operating system kernel 114. For a non-limiting example, such function calls can be provided by Portable Operating System Interface (POSIX) of the operating system kernel 114. Here, the operating system kernel 114 controls resources (such as the physical storage device 116) of the hosting device 102 for the file encryption/decryption component 108 and the operating system libraries 112 to access. Since the file is encrypted and/or decrypted by the file encryption/decryption component 108, no additional encryption and/or decryption is performed on the storage blocks of the physical storage device 116.

In some embodiments, the file encryption/decryption component 108 encrypts and/or decrypts the file to be accessed by the application 106 transparently on a per-file basis without requiring any changes to the source code of the application 106, the kernel, the libraries, and any proprietary component of the operating system. Specifically, the file encryption/decryption component 108 manages metadata of files used by the application 106 without changing files of the application 106, wherein the metadata includes information on which of the file(s) are to be encrypted/decrypted or to be left alone (unencrypted). Maintaining encryption information on the files is important since such encryption information cannot be identified simply based on the content of the file (e.g., source code of the application 106).

In the example of FIG. 1, a metadata database 110 is configured to store and maintain metadata on files marked for encryption and/or decryption by the file encryption/decryption component 108. In some embodiments, the metadata database 110 runs on an apparatus/host separated from the hosting device 102 of the file encryption/decryption component 108. In some embodiments, metadata in the metadata database 110 includes a list of files to be encrypted/decrypted and the unencrypted sizes of the files marked for encryption and/or decryption (which are required for the encryption/decryption of the files), wherein the files are located on one or more disks/volumes of the physical storage device 116. For a non-limiting example, the metadata database 110 may include records of fixed-width-per-record text, wherein each record includes path and size of a file to be encrypted/decrypted as shown below:

| Filepath (256 Octets, Zero-Padded) | File size (8 Octets) |
|---|---|
| /path/to/file.txt | 12345 |

In some embodiments, the metadata database 110 can be once-per-system, i.e., one centralized copy of the metadata per physical storage device 116, once-per volume (such as in the root directory of each volume) of the system, or once-per-directory on one of the volumes. In some embodiments, the metadata database 110 itself may be encrypted as well in order to foil attempts to discover metadata information stored in the metadata database 110 such as which files are encrypted.

In some embodiments, the metadata in the metadata database 110 can be organized in XML format, or in various binary database structures such as a B-tree. In some embodiments, the metadata can include numerous attributes in addition to file path and file size, wherein such attributes can be but are not limited to one or more of, an encryption key index or other key selector (if there is more than one encryption key in use), flags to specify encryption method (or even the “no encryption” method, meaning that the file has been explicitly left unencrypted on the physical storage device 116), or other notes such as licensing information of the files.

In some embodiments, the metadata including indications that one or more files are to be encrypted is maintained in an indicator file in a file system by the file encryption/decryption component 108 in addition to or as an alternative to the metadata database 110, wherein , the indicator file may include any of the metadata (e.g., size, encryption key information, etc.) discussed above. For a non-limiting example, a file “/foojbar.txt” may have a companion file named “/fooj.bar.txt” or “/fooj.bar.txt.encrypted” contains metadata of the original file in the same directory. In some embodiments, the file encryption/decryption component 108 may detect the existence of such indicator file, which existence alone is enough to trigger file encryption/decryption component 108 to perform encryption and/or decryption operation on the file. In some embodiments, the indicator file can be hidden by the operating system of the hosting device 102 and not visible to the user.

In some embodiments, the file encryption/decryption component 108 utilizes a block encryption approach to encrypt and/or decrypt the file on a per-file basis using an encryption method such as AES. The file encryption/decryption component 108 further determines, maintains, and reports the actual unencrypted size of an encrypted file for entry in the metadata database 110 and/or reporting to the application 106. Under such block encryption approach, the size of a block-encrypted file is padded into even multiples of the block size rounding up to the next multiple (e.g. a 17 -byte file must be padded to 32-bytes on a disk of the physical storage device 116 if the block size is 16-bytes) on the physical storage device 116. As such, size of an encrypted file is typically larger than the size of the original (unencrypted) file. In some embodiments, the file encryption/decryption component 108 transforms function calls used by the operating system libraries 112 and/or operating system kernel 114 to report a file size (such as POSIX call stat( )) so that the actual size of the unencrypted file, not the actual number of bytes of the encrypted file stored on the physical storage device 116, is reported.

In some embodiments, where the encrypted files are padded, the file encryption/decryption component 108 is configured to operate a padding method such as PKCS7 and/or ANSI X.923 on the encrypted file in reverse to determine what the unencrypted size of the file is based on the number of bytes of the encrypted (padded) file written to the physical storage device 116. Specifically, the file encryption/decryption component 108 first reads the size of the encrypted file stored on the physical storage device 116. The file encryption/decryption component 108 then opens the file and seek to/read the last block to determine the number of bytes of padding in the file. The file encryption/decryption component 108 then subtracts the padding number from the size of the encrypted file stored on the physical storage device 116 and reports that number to the requesting application.

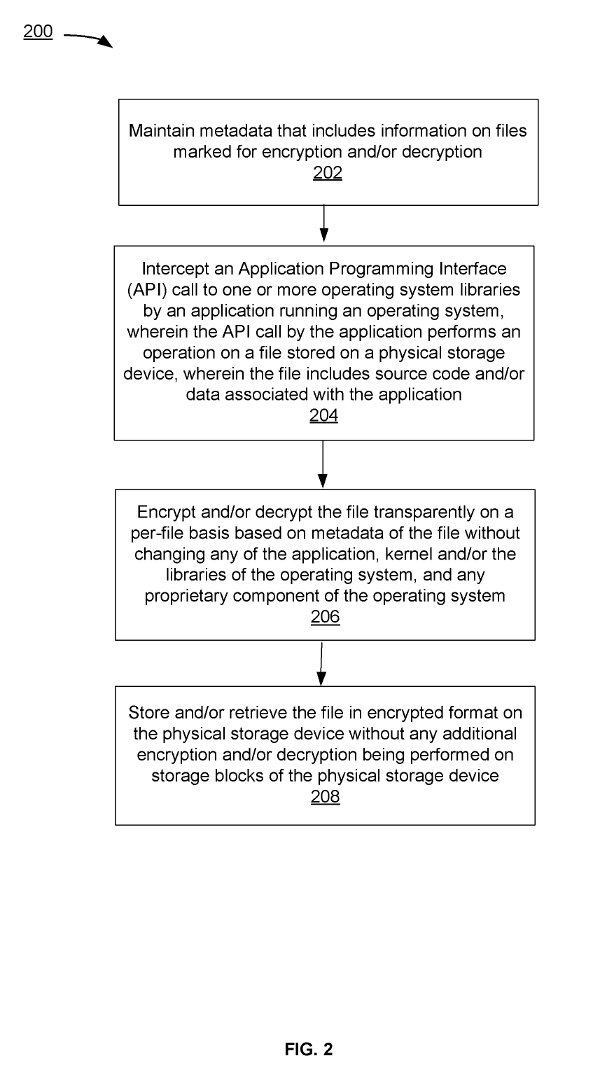

FIG. 2 depicts a flowchart of an example of a process to support encryption and decryption on per-file basis via metadata identification. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 2, the flowchart 200 starts at block 202, where metadata that includes information on files marked for encryption and/or decryption is maintained either in a metadata database or an indicator file. The flowchart 200 continues to block 204, where an Application Programming Interface (API) call to one or more operating system libraries by an application running on an operating system is intercepted, wherein the API call by the application performs an operation on a file stored on a physical storage device, and the file includes source code and/or data associated with the application. The flowchart 200 continues to block 206, where the file is encrypted and/or decrypted transparently on a per-file basis based on metadata of the file without changing any of the application, kernel and/or the libraries of the operating system, or any proprietary component of the operating system based on metadata of the file. The flowchart 200 end at block 208 where the file is stored and/or retrieved in encrypted format on the physical storage device without any additional encryption and/or decryption being performed on storage blocks of the physical storage device.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system, comprising:
a file encryption/decryption component running on a host, which in operation, is configured to
intercept an Application Programming Interface (API) call to one or more operating system libraries by an application running on an operating system, wherein the API call by the application performs an operation on a file stored on a physical storage device of the host, wherein the file includes source code and/or data associated with the application;
encrypt and/or decrypt the file transparently on a per-file basis based on metadata of the file without changing any of the application, kernel and/or the libraries of the operating system, and any proprietary component of the operating system;
store and/or retrieve the file in encrypted format on the physical storage device of the host without any additional encryption and/or decryption being performed on storage blocks of the physical storage device;
a metadata database running on a host, which in operation, is configured to maintain metadata that includes information on files marked for encryption and/or decryption.

2. The system of claim 1, wherein:
the file encryption/decryption component is logically interposed between the application and the operating system libraries.

3. The system of claim 1, wherein:
the application is a virtual application running in a virtual environment, which is a software implementation to emulate an existing computing environment.

4. The system of claim 3, wherein:
the application interacts with a virtual disk in the virtual environment, which is a virtual logical disk mapped to the physical storage device.

5. The system of claim 1, wherein:
the source code of the application is written in an interpreted language, which is an executable plain text script stored on the physical storage device.

6. The system of claim 1, wherein:
the file encryption/decryption component is configured to encrypt and/or decrypt only a portion of the file related to confidential information or intellectual property of an entity that owns the file.

7. The system of claim 1, wherein:
the file encryption/decryption component is configured to enable API calls that are unrelated to operations on the file to pass through to the operating system libraries without alteration.

8. The system of claim 1, wherein:
the file encryption/decryption component is configured to encrypt and/or decrypt the file by dynamically altering a link to a library for the API call.

9. The system of claim 1, wherein:
the file encryption/decryption component is configured to dynamically redirect the API call to the operating system libraries to an alternative library to encrypt the file for a write operation and to decrypt the file for a read operation.

10. The system of claim 9, wherein:
the file encryption/decryption component is configured to dynamically redirect a link to the alternative library using a library preloading setting, which specifies a program library whose functions override the subsequently loaded operating system libraries.

11. The system of claim 1, wherein:
the file encryption/decryption component is configured to store and/or retrieve the file in encrypted format on the physical storage device via function calls provided by interface of an operating system kernel.

12. The system of claim 11, wherein:
the interface of an operating system kernel is Portable Operating System Interface (POSIX).

13. The system of claim 1, wherein:
the file encryption/decryption component is configured to maintain the metadata including indications that one or more files are to be encrypted in an indicator file in a file system in addition to or as an alternative to the metadata database.

14. The system of claim 13, wherein:
the file encryption/decryption component is configured to detect existence of the indicator file, which triggers the file encryption/decryption component to encrypt and/or decrypt the file.

15. The system of claim 1, wherein:
the file encryption/decryption component is configured to utilize a block encryption approach to encrypt and/or decrypt the file on a per-file basis.

16. The system of claim 1, wherein:
the metadata database is encrypted to prevent discovery of metadata stored in the metadata database.

17. The system of claim 1, wherein:
the metadata in the metadata database includes unencrypted sizes of the files marked for encryption and/or decryption.

18. The system of claim 17, wherein:
the file encryption/decryption component is configured to determine and report the unencrypted size of an encrypted file for entry in the metadata database and/or reporting to the application.

19. The system of claim 18, wherein:
the file encryption/decryption component is configured to operate a padding method on the encrypted file in reverse to determine what the unencrypted size of the file is based on number of bytes of the encrypted file on the physical storage device.

20. A computer-implemented method, comprising:
maintaining metadata that includes information on files marked for encryption and/or decryption;
intercepting an Application Programming Interface (API) call to one or more operating system libraries by an application running on an operating system, wherein the API call by the application performs an operation on a file stored on a physical storage device, wherein the file includes source code and/or data associated with the application;
encrypting and/or decrypting the file transparently on a per-file basis based on metadata of the file without changing any of the application, kernel and/or the libraries of the operating system, and any proprietary component of the operating system based on metadata of the file;
storing and/or retrieving the file in encrypted format on the physical storage device without any additional encryption and/or decryption being performed on storage blocks of the physical storage device.

21. The method of claim 20, further comprising:
enabling API calls that are unrelated to operations on the file to pass through to the operating system libraries without alteration.

22. The method of claim 20, further comprising:
encrypting and/or decrypting only a portion of the file related to confidential information or intellectual property of an entity that owns the file.

23. The method of claim 20, further comprising:
encrypting and/or decrypting the file by dynamically altering a link to a library for the API call.

24. The method of claim 20, further comprising:
dynamically redirecting the API call to the operating system libraries to an alternative library to encrypt the file for a write operation and to decrypt the file for a read operation.

25. The method of claim 24, further comprising:
dynamically redirecting a link to the alternative library using a library preloading setting, which specifies a program library whose functions override the subsequently loaded operating system libraries.

26. The method of claim 20, further comprising:
storing and/or retrieving the file in encrypted format on the physical storage device via function calls provided by interface of an operating system kernel.

27. The method of claim 20, further comprising:
maintaining the metadata including indications that one or more files are to be encrypted in an indicator file in a file system in addition to or as an alternative to a metadata database.

28. The method of claim 27, further comprising:
detecting existence of the indicator file, which triggers the file encryption/decryption component to encrypt and/or decrypt the file.

29. The method of claim 20, further comprising:
utilizing a block encryption approach to encrypt and/or decrypt the file on a per-file basis.

30. The method of claim 20, further comprising:
determining and reporting unencrypted size of an encrypted file for entry in the metadata database and/or reporting to the application.

31. The method of claim 30, further comprising:
operating a padding method on the encrypted file in reverse to determine what the unencrypted size of the file is based on number of bytes of the encrypted file on the physical storage device.

32. A non-transitory computer readable medium having software instructions stored thereon that when executed cause a system to:
maintain metadata that includes information on files marked for encryption and/or decryption;
intercept an Application Programming Interface (API) call to one or more operating system libraries by an application running on an operating system, wherein the API call by the application performs an operation on a file stored on a physical storage device, wherein the file includes source code and/or data associated with the application;
encrypt and/or decrypt the file transparently on a per-file basis based on metadata of the file without changing any of the application, kernel and/or the libraries of the operating system, and any proprietary component of the operating system based on metadata of the file;
store and/or retrieve the file in encrypted format on the physical storage device without any additional encryption and/or decryption being performed on storage blocks of the physical storage device.
